(19) United States
(12) Patent Application Publication
(10) Pub. No.: US 2010/0008841 A1
(43) Pub. Date: Jan. 14, 2010

(54) Method for the Manufacture of Silicon Tetrachloride

(76) Inventor: Christian Rosenkilde, Porsgrunn (NO)

Correspondence Address: WENDEROTH, LIND & PONACK, L.L.P., 1030 15th Street, N.W.,, Suite 400 East, Washington, DC, 20005-1503, US

(21) Appl. No.: 12/227,118

(22) PCT Filed: May 4, 2007
(86) PCT No.: PCT/NO2007/000155

§ 371 Date: Jun. 8, 2009

(30) Foreign Application Priority Data
May 10, 2006 (DE) 10 2006 021856.6
May 10, 2006 (DE) 10 2006 021858.2

(51) Int. Cl. C01B 33/08; C01B 33/02

(52) U.S. Cl. 423/341; 423/350

(57) ABSTRACT

The invention concerns a method for the manufacture of silicon tetrachloride by conversion of a mixture of finely divided and/or amorphous silicon dioxide, carbon and an energy donator with chlorine. Energy donators are metallic or silicon alloys such as silicon, ferrosilicon or calcium suicide. The addition of the donors effects a self-sustaining, exothermic reaction on one hand and a significant lowering of the reaction starting temperature on the other hand.

As finely divided and/or amorphous silicon dioxide ashes containing silicon dioxide are primarily used. These are produced by the incineration of silicon-containing plant skeletal structures such as rice husks or straw. Other sources include silicas from the digestion of alkaline earth silicates with hydrochloric acid and filtered particulate from the electrochemical manufacture of silicon, as well as naturally occurring products containing silicon dioxide, such as diatomaceous earth kieselguhr).

The present invention concerns a method for the manufacture of silicon tetrachloride by conversion of a concentrated mixture of finely divided and/or amorphous silicon dioxide, carbon and an energy donator with chlorine. The task of the invention was to develop a method for the manufacture of SiCl₄ that is economical and technologically simple to implement. In addition to having low energy requirements, the method should enable the use of renewable raw materials.

Silicon tetrachloride finds increasing application in large quantities as a starting product for the manufacture of highly disperse pyrogenic silicas used as reinforcing fillers for silicone polymers, thixotropic agent and as a core material for microporous insulation materials, but especially also as a starting material for high purity silicon for photovoltaic and semiconductor technology. In this regard, depending on the deposition technology used, it may be necessary to hydrogenate SiCl₄ to form HSiCl₃ or SiH₄. For successful market development and growth of the market for semiconductor silicon, electronics and especially photovoltaic technology, the economic aspect is important. Particularly with photovoltaics, this is the ratio of energy expended to energy generated. Consequently, the manufacturing processes must ensue with minimal expenditure of energy and maximum material utilisation. Furthermore, with the continual decline in natural resources, the use of renewable materials is important.

The conversion of materials containing SiO₂ by reaction with chlorine in the presence of carbon is known as carbochlorination.

The reaction proceeds according to the following equation:

SiO2+2C+2Cl₂→SiCl₄+2CO

The reaction takes place at temperatures above 1100° C. However, the technical implementation of this reaction encounters considerable difficulties, since the reaction is endothermic due to negative reaction enthalpy. To ensure a constant process, energy must be added continuously.

De 1079015 describes the addition of energy by means of an electric arc. This method is technically cumbersome, has many weak points and can be implemented only with difficulty. Thus, among other things, the gas path from the reaction chamber can be kept open only with difficulty.

DE 3438444/A1 and EP 0077138 describe options to reduce the reaction temperature to 500-1200° C. through the use of catalysts. Catalysts used are chloro compounds of fifth and third main and secondary group of the periodic table. The chlorides BCl₃ (boron trichloride) and POCl₃(phosphorous oxytrichloride) are preferred. This use effects a somewhat more even energy balance, since according to the Boudouard equilibrium, at reaction temperatures below 800° C. in addition to carbon monoxide, proportions of carbon dioxide are also formed. Nonetheless, energy must be added to the process steadily to ensure that it is uninterrupted.

Furthermore, the use of catalysts such as boron trichloride (BCl₃) leads to impurities. These are very detrimental for various applications of SiCl₄ for high purity silicon in the semiconductor field, since even traces of boron in the ppm range are not acceptable. It was found that a reaction mixture of carbon, finely divided and/or amorphous silicon dioxide and metallic silicon and/or ferrosilicon reacts quickly and completely without additional energy to form silicon tetrachloride.

The silicon dioxide used in accordance with the invention has a finely divided and/or amorphous structure. The specific surface area, measured according to the BET method, amounts to least 10 m²/g. The SiO₂ content is between 70 and 100 weight percent.

Examples of materials containing silicon dioxide used in accordance with the invention are:
Ashes containing silicon dioxide, which are produced by the incineration of plant skeletal structures, such as rice husks or straw from a wide variety of grain types. In addition to their renewable availability, these materials also have the advantage of having finely distributed carbon in their structures, which has a positive influence on the reaction. These ashes show a high reactivity, demonstrated by a low reaction temperature (below 1200° C.), a fast reaction rate and high yield.
Silicas produced by the digestion of silicates, such as CaSiO₃ and MgSiO₃, with hydrochloric acid. Such silicas can be produced, for example, as a side product during the digestion of olivine (Mg(Fe))₂SiO₄ with aqueous hydrochloric acid to manufacture MgCl₂. The MgCl₂ is used as a raw material in the electrolysis process for the manufacture of magnesium. Chlorine is produced as part of this, which in turn is used in the carbochlorination process for the manufacture of SiCl₄.
Flue dust resulting from the large scale electrochemical manufacturing process for silicon. This flue dust also contains adherent carbon.
Natural occurring silicon dioxide products, such as diatomaceous and infusion earths, such as kieselguhrs and siliceous chalks.
In accordance with the invention, carbon is used in finely divided form. Examples for the carbon are:
   Finely ground coal, coke and activated charcoal as well as their dusts. Preferably soots are used due to their high activity.

The chlorine to be used for the reaction can come from the electrolysis of chlorides from the main group I and II and the transition metals of the periodic table, preferably from magnesium chloride. The chlorine used must be nearly anhydrous (<10 ppm), since excessive moisture causes a reverse reaction of the SiCl₄ to form SiO₂.

In accordance with the invention, silicon, ferrosilicon and calcium silicide are used as an energy donator for the reaction. These compounds are distinguished by high reaction enthalpies released in the reaction with chlorine, which are between 500 and 750 kJ/mol. These compounds participate as an energy donator in the reaction with chlorine and also form the target product SiCl₄, thus increasing the yield. There are no impurities to be removed or only very low concentrations (depending on the type of energy carrier used).

The use of the inventive energy donators leads to a considerable lowering of the reaction starting temperature, which would be above 1000° C. without these donators. Depending on the grain size of the product used, the temperature can be lowered by as much as 300° C.

Compounds preferred as an energy donator for the reaction are those with a silicon content higher than 80 weight percent. Products with a lower proportion of silicon result in too great an incidence of undesired side products. With the use of ferrosilicon, it is primarily iron (III) chloride; with the use of calcium silicide, it is calcium (II) chloride. The grain size of the metallic silicon or of the compound containing metallic silicon should be less than 3 mm, preferably less than 1.5 mm. The finest dusts in the μm range have proven most suitable for the purpose.

The reaction temperature and reaction rate as well as the evolution of heat can be controlled by the quantity of metallic silicon compounds added. Through the use of finely dispersed SiO₂ and metallic silicon compounds as energy sources, the reaction temperature, surprisingly, can also be reduced below 1100° C.

For an exothermic progression of the chlorination reaction, depending on the heat control and activity of the two other raw materials, silicon dioxide and carbon, 5-90 weight percent of finely divided silicon or ferrosilicon (preferably 2-20 weight percent) is added as an energy carrier. The molar ratio of silicon dioxide to carbon amounts to 1 to 2.5, preferably 1 to 1.8.

The components are mixed intimately for the reaction, with a little aqueous starch if necessary, and then pressed into pellets. With the addition of binding agents (such as aqueous starch), after the pellets are made, they are dried at approximately 200° C. The silicon tetrachloride vapour produced during the reaction is condensed and put in intermediate storage if necessary. Impurities are removed by means capable of trapping trace concentrations and by distillation.

### EXAMPLES

### Method for the Manufacture of Silicon Tetrachloride:

1) A mixture of 120 g rice husk ashes, 30 g soot (surface area according to BET: 20 m²/g) und 12 g metallic silicon dust (grain size<0.8 mm) was formed in a press to make cylindrical bodies 5 mm in diameter with a length of 10 mm, which were then dried at 200° C.

The pellets were exposed to a stream of chlorine gas of 280 Nl/h in a quartz tube 70 mm in diameter at a temperature of 350° C. After the start of the reaction the heating was shut off. The reaction continued thereafter exothermically and in a self-supporting manner without further heating at 1050° C.

The resultant reaction products were condensed with a cooler. Yield: 412 g SiCl₄<95% (with reference to the SiO₂ used). No chlorine could be found in the waste gas.

2) A mixture of 180 g silica (BET surface area 230 m²/g), produced by the digestion of olivine with aqueous HCl, and 20 g metallic ferrosilicon (Si content 90 weight percent, Fe content 10 weight percent) was combined with 50 ml water and pressed to form pellets 5 mm in diameter and 10 mm long and subsequently dried at 200° C.

The pellets were placed in a heatable quartz tube 70 mm in diameter. The reactor was heated to 350° C. Afterward the mixture was brought to reaction with a chlorine stream of 350 Nl/h, and the heating was shut off. The reaction continued to run without heating at 1100° C.

The yield was 590 g SiCl4 (>95 weight percent); chlorine could not be found.

1. A method for the manufacture of silicon tetrachloride by reaction of finely divided and/or amorphous silicon dioxide with chlorine in the presence of carbon and an energy donator, characterised in that
a) the silicon dioxide used is finely divided and/or amorphous in structure
b) the energy donator is metallic silicon or silicon alloys such as ferrosilicon or calcium silicide.

2. A method according to claim 1, characterised in that the amorphous silicon dioxide used
a) is ashes containing silicon dioxide, which were produced from the incineration of plant skeletal structures such as those from rice husks or straw from a wide variety of grain types
b) is silica produced from the digestion of CaSiO₃ and MgSiO₃ (olivine) with hydrochloric acid
c) is SiO₂ filter dusts from the electrochemical manufacturing process for silicon
d) are naturally occurring silicon dioxide products, such as diatomaceous earths and infusion earths.

3. A method according to claim 1, characterised in that the silicon, ferrosilicon or calcium silicide used as an energy donator
a) is used in quantities of 2-90 weight percent, preferably 5-20 weight percent
b) has a grain size less than 3 mm, preferably less than 1.5 mm.

4. A method according to claim 1, characterised in that the chlorine used for the reaction results from an electrolysis process of alkali and/or alkaline earth chlorides and/or transition metal chlorides, preferably sodium chloride, magnesium chloride and zinc chloride.

5. A method according to claim 1, characterised in that the solid components used are specifically employed as pellets.

6. A method according to claim 1, characterised in that the silicon tetrachloride manufactured in accordance with the invention is used directly, or after hydrogenation to form silanes or hydrosilanes, for the manufacture of high purity silicon.

7. A method according to claim 2, characterised in that the silicon, ferrosilicon or calcium silicide used as an energy donator
a) is used in quantities of 2-90 weight percent, preferably 5-20 weight percent
b) has a grain size less than 3 mm, preferably less than 1.5 mm.

8. A method according to claim 2, characterised in that the chlorine used for the reaction results from an electrolysis process of alkali and/or alkaline earth chlorides and/or transition metal chlorides, preferably sodium chloride, magnesium chloride and zinc chloride.

9. A method according to claim 3, characterised in that the chlorine used for the reaction results from an electrolysis process of alkali and/or alkaline earth chlorides and/or transition metal chlorides, preferably sodium chloride, magnesium chloride and zinc chloride.

10. A method according to claim 2, characterised in that the solid components used are specifically employed as pellets.

11. A method according to claim 3, characterised in that the solid components used are specifically employed as pellets.

12. A method according to claim 4, characterised in that the solid components used are specifically employed as pellets.

13. A method according to claim 2, characterised in that the silicon tetrachloride manufactured in accordance with the invention is used directly, or after hydrogenation to form silanes or hydrosilanes, for the manufacture of high purity silicon.

14. A method according to claim 3, characterised in that the silicon tetrachloride manufactured in accordance with the invention is used directly, or after hydrogenation to form silanes or hydrosilanes, for the manufacture of high purity silicon.

15. A method according to claim 4, characterised in that the silicon tetrachloride manufactured in accordance with the invention is used directly, or after hydrogenation to form silanes or hydrosilanes, for the manufacture of high purity silicon.

16. A method according to claim 5, characterised in that the silicon tetrachloride manufactured in accordance with the invention is used directly, or after hydrogenation to form silanes or hydrosilanes, for the manufacture of high purity silicon.
